(19) United States
(12) Patent Application Publication
(10) Pub. No.: US 2025/0208252 A1
(43) Pub. Date: Jun. 26, 2025

(54) COOPERATIVE ISAC METHOD AND SYSTEM WITH MULTIPLE BASE STATION BASED ON DEEP LEARNING

(71) Applicant: Korea Advanced Institute of Science and Technology, Daejeon (KR)

(72) Inventors: Hyuncheol PARK, Daejeon (KR); Jeongju JEE, Daejeon (KR)

(21) Appl. No.: 18/818,474

(22) Filed: Aug. 28, 2024

(30) Foreign Application Priority Data
Dec. 22, 2023 (KR) 10-2023-0189684
Jul. 16, 2024 (KR) 10-2024-0093465

(51) Int. Cl. G01S 7/00

(52) U.S. Cl. CPC G01S 7/006

(57) ABSTRACT

Disclosed is a multi-base station-based cooperative integrated sensing and communication (ISAC) method and system using deep learning. A multi-base station-based cooperative ISAC method performed by a cooperative ISAC system may include inputting, to a second network, result data acquired from channel information acquired at each base station and location data of a target through a first network; and outputting a beamforming matrix for ISAC of each base station through the second network.

### CROSS-REFERENCE TO RELATED APPLICATION(S)

This application claims the priority benefit of Korean Patent Application No. 10-2023-0189684, filed on Dec. 22, 2023, 10-2024-0093465, filed on Jul. 16, 2024, in the Korean Intellectual Property Office, the disclosure of which is incorporated herein by reference.

### BACKGROUND

### 1. Field of the Invention

Example embodiments relate to integrated sensing and communication (ISAC) technology for simultaneously performing wireless communication and radar sensing in a base station.

### 2. Description of the Related Art

In post-5G mobile communication standards, use case is emerging in which a mobile network detects locations and behaviors of a user and an object and uses the acquired information to support various user-customized services.

To support this use case, each base station may need to be able to support sensing technology capable of detecting locations of a user and an object through radar technology as well as wireless communication. However, introducing separate radar equipment and technology to each base station causes installation and implementation cost issues.

Integrated sensing and communication (ISAC) technology refers to technology that supports mobile user traffic through single radio wave transmission by combining communication and sensing technology and, at the same time, estimates a location and a speed of an object to be sensed. The ISAC technology is evaluated as technology capable of reducing installation cost and implementation cost of hardware for beyond 5G mobile communication network.

However, in a high frequency band that includes a millimeter wave band, which is expected to be used in future mobile communication, sensing coverage is reduced due to signal loss by path attenuation and blockage. In particular, sensing technology that requires securing a line-of-sight (LoS) path has the limitation of being difficult to use in a millimeter wave band.

### SUMMARY

Example embodiments may provide a cooperative integrated sensing and communication (ISAC) method and system using a plurality of base stations to secure a line-of-sight (LoS) path and to achieve a high transmission rate through cooperative beamforming.

To solve the limitation that multi-base station beamforming has high optimization complexity, example embodiments may provide a method and system for designing a beam using channel information and location data of a sensing target through a deep learning-based communication and sensing model.

According to an aspect, there is provided a multi-base station-based cooperative ISAC method performed by a cooperative ISAC system, the cooperative ISAC method including inputting, to a second network, result data acquired from channel information acquired at each base station and location data of a target through a first network; and outputting a beamforming matrix for ISAC of each base station through the second network.

The first network and the second network may be connected and trained as a single neural network.

The first network may be processed at a central apparatus, and the second network may be processed at each base station.

The first network and the second network may be configured as a fully-connected network or a convolutional neural network.

The first network and the second network may be trained to maximize a weighted sum of a negative value of a measure of evaluating sensing performance and a transmission rate that is an index of evaluating communication performance.

The cooperative ISAC method may further include acquiring channel information from each base station by estimating a channel between a user terminal and the base station.

The cooperative ISAC method may further include transmitting location data of a target in a previous timestamp to a central apparatus based on the channel information acquired from each base station and a current timestamp.

The central apparatus may be configured to deliver, to each base station, result data acquired using the location data of the target in the previous timestamp based on the channel information acquired at each base station and the current timestamp through the first network.

The outputting may include performing downlink-based ISAC by multiplying the output beamforming matrix for ISAC of each base station by a data stream and a radar signal for communication.

The outputting may include supporting communication traffic of a user terminal, and at the same time, estimating location data of a target through a beam formed based on the output beamforming matrix for ISAC of each base station.

According to another aspect, there is provided a non-transitory computer-readable recording medium storing instructions that, when executed by a processor, cause the processor to perform a multi-base station-based cooperative ISAC method performed by a cooperative ISAC system, the cooperative ISAC method including inputting, to a second network, result data acquired from channel information acquired at each base station and location data of a target through a first network; and outputting a beamforming matrix for ISAC of each base station through the second network.

According to still another aspect, there is provided a multi-base station-based cooperative ISAC system including a data input unit configured to input, to a second network, result data acquired from channel information acquired at each base station and location data of a target through a first network; and a beamforming matrix output unit configured to output a beamforming matrix for ISAC of each base station through the second network.

According to some example embodiment, it is possible to simultaneously achieve high location estimation performance and a high transmission rate by efficiently optimizing beam design and scheduling in a multi-base station-based ISAC network, which is a very complex issue to solve in real time.

Also, according to some example embodiments, it is possible to design a beam for robust ISAC to well transmit a beam to a target of which a location varies over time, by performing learning based on location coordinate data in a previous timestamp rather than an actual location of a sensing target.

According to some example embodiments, it is possible to realize millimeter wave band ISAC by optimizing an ISAC network, which is difficult to optimize in real time, and by performing an ISAC function using multiple base stations, and at the same time, to contribute to realizing an application that acquires and uses information, such as a location, a speed, and a behavior of a user.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a network environment for describing a cooperative integrated sensing and communication (ISAC) system according to an example embodiment;

FIG. 2 illustrates an example of a learning operation of a cooperative ISAC system according to an example embodiment;

FIG. 3 is a block diagram illustrating a cooperative ISAC system according to an example embodiment;

FIG. 4 is a flowchart illustrating a multi-base station-based cooperative ISAC method according to an example embodiment;

FIG. 5 is a graph showing technical effect of a multi-base station-based cooperative ISAC method proposed herein according to an example embodiment; and

FIG. 6 is another graph showing technical effect of a multi-base station-based cooperative ISAC method proposed herein according to an example embodiment.

### DETAILED DESCRIPTION

Hereinafter, example embodiments will be described with reference to the accompanying drawings.

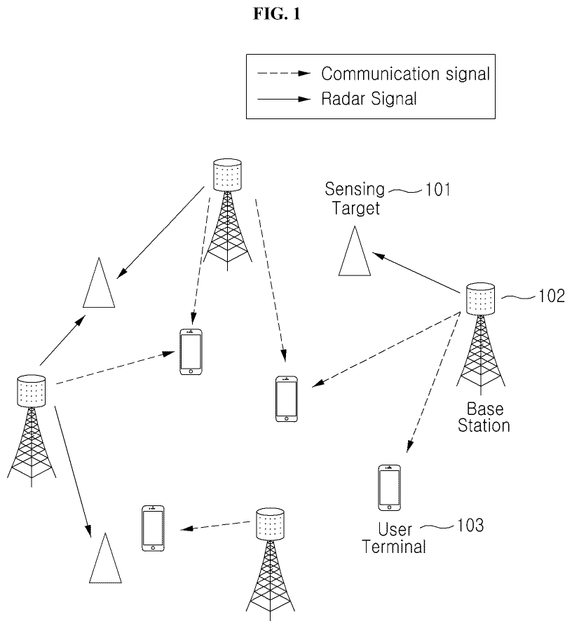

FIG. 1 illustrates a network environment for describing a cooperative integrated sensing and communication (ISAC) system according to an example embodiment.

In an example embodiment, a network environment in which a plurality of base stations 102 and a plurality of user terminals 103 are present is assumed. The base station 102 is equipped with a plurality of antennas. In a network, a plurality of sensing targets 101 is present. The sensing target 101 may be the user terminal 103 and a target separate from the user terminal 103.

The plurality of base stations 102 may need to support communication traffic of the user terminal 103 by designing cooperative beamforming, and at the same time, to perform sensing by forming a beam in the sensing target 101. To this end, it is necessary to determine which base station 102 senses which target and for which user terminal 103 to form a beam and allocate power. Simultaneously designing this process is highly complex and requires a lot of information.

Also, most ISAC technology designs a beam based on location data in the existing timestamp. However, in reality, a location of a target changes over time and a positioning error may occur. Therefore, it is necessary to solve this issue. Accordingly, technology for designing cooperative ISAC based on deep learning that may efficiently solve the aforementioned issue is described.

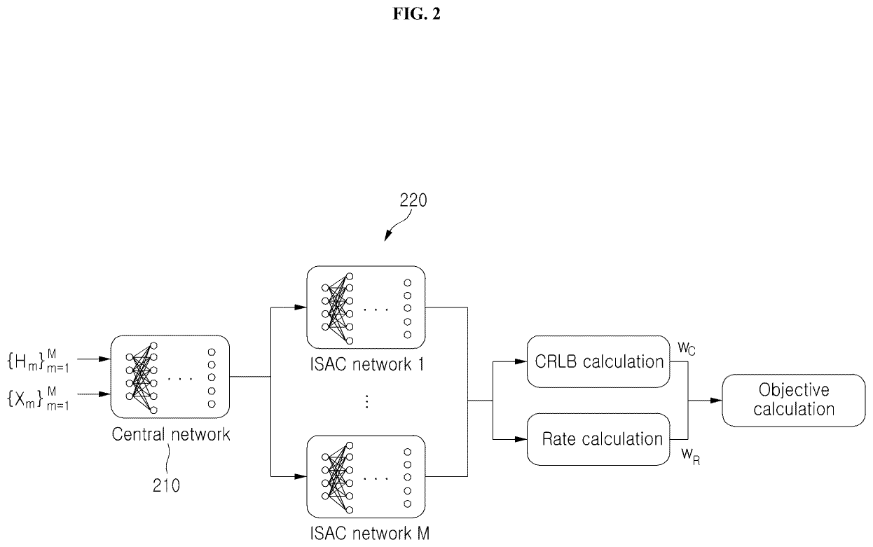

FIG. 2 illustrates an example of a learning operation of a cooperative ISAC system according to an example embodiment.

The cooperative ISAC system may provide a beam design technique for multi-base station-based cooperative ISAC using deep learning. In an example embodiment, a cooperative ISAC operation of sensing a plurality of targets using a plurality of base stations and at the same time, supporting communication traffic in a plurality of user terminals is described.

The cooperative ISAC system may construct a deep learning-based cooperative communication and sensing model. Here, the cooperative communication and sensing model may include two types of artificial networks, a first network 210 and a second network 220. The first network 210 may be processed at a central apparatus and the second network 220 may be processed at each base station. Here, the first network 210 and the second network 220 may include a fully-connected network or a convolutional neural network.

Referring to FIG. 2, the first network 210 is named a central network and the second network 220 is name an ISAC network. The first network 210 and the second network 220 are connected and trained as one network, and may be trained with an unsupervised learning method of maximizing a weighted sum of a Cramer-Rao lower bound that is a measure of sensing performance and a measure of communication performance.

Each base station may transmit, to the central apparatus, channel information acquired at each base station and location data at a previous timestamp. The central apparatus may acquire result data (result value) output by allowing the channel information acquired at each base station and the location data at the previous timestamp to pass the first network 210 and may transmit the acquired result data to each base station. For example, the central apparatus may output M pieces of data in the form of a vector as the result data of the first network 210. Here, N denotes a natural number. The M pieces of data may be delivered to each base station and used to generate a beamforming matrix. Here, the result data may perform a role of a message that allows each base station to generate a beamforming matrix. In this process, information related to a user terminal supported by each base station, power allocation, and a sensing-support user terminal may be transmitted to each base station.

Each base station may input the result data of the first network 210 to the second network 220 and may output a beamforming matrix for ISAC. Each base station may support each user terminal by forming a beam based on an output beamforming matrix and, at the same time, may verify location data of a target by transmitting the beam to each target.

In detail, a beam design technique for multi-base station-based cooperative ISAC may include a training stage and an execution stage. The training stage is performed offline in a state in which all data is collected, and the execution stage is a process of operating ISAC using a trained network.

In the training stage, as shown in FIG. 2, the first network 210 and the second network 220 may be trained. Result data output from the first network 210 may be applied as input data to the second network 220.

The first network 210 may receive channel information (e.g., channel state information (CSI)) acquired at each base station and location data (e.g., coordinate data) of the target as input data. This process may be expressed as the following equation.

[y₁, . . . ,y_{M}]=f_{cen}(H₁, . . . ,H_{M},X₁, . . . ,X_{K};Θ_{cen})Fₘ=f_{ISAC,m}(yₘ;Θ_{ISAC,m})

Here, M denotes the number of base stations, f_{cen} and f_{ISAC,m} denote artificial nueral networks executed in a first network 210 and an m^{th} second network, respectively, and Θ_{cen} and Θ_{ISAC,m} denote parameters included in the respective artificial neural networks. Hₘ, yₘ, and Fₘ denote a channel matrix of an m^{th} base station, a parameter transmitted to the m^{th} base station among output of the first network 210, and a beamforming matrix for ISAC of the m^{th} base station, respectively. xₖ may be defined as location coordinate data of a k^{th} target.

The first network 210 and the second network 220 may be trained to maximize a weighted sum of a negative value of CRLB, which is a measure of evaluating sensing performance, and a transmission rate, which is an index of evaluating communication performance. Therefore, a loss function for training the entire network may be expressed as follows.

$$l = - {w}_{R} {\sum }_{u = 1}^{U} {log}_{2} ( 1 + {SINR}_{u} ) + {w}_{C} {\sum }_{k = 1}^{K} {CRLB}_{k}$$

Here, U and K denote the number of user terminals and the number of (sensing) targets, respectively, and w_{R} and w_{C} dente weight values multiplied by the CRLB and the transmission rate, respectively. SINRᵤ and CRLBₖ denote a signal-to-interference-plus-noise ratio (SINR) of a u^{th} user terminal and CRLB for a k^{th} user terminal, respectively. The corresponding equation may be differently set for each system.

The weighted values w_{R} and w_{C} may be differently selected in a system design process. When placing importance on communication performance, w_{R} may increase. When placing importance on sensing performance, w_{C} may increase.

After the first network 210 and the second network 220 are trained to minimize a loss function, the first network 210 may operate in the central apparatus and the second network 220 may operate in each base station.

Each base station may estimate a channel between the user terminal (communication user) and the base station and may transmit location data (location value) of the target estimated in a previous timestamp to the first network 210.

The central apparatus may acquire result data y₁, . . . , y_{M} by inputting information collected from each base station to the first network 210. The central apparatus may deliver the result data to each base station.

Each base station may acquire a beamforming matrix Fₘ by inputting the result data delivered from the central apparatus to the second network 220. Each base station may perform downlink-based cooperative ISAC by multiplying the beamforming matrix Fₘ by a data stream and a radar signal for communication. That is, the data stream represents a downlink data stream transmitted from the base station to each user terminal and the radar signal may be a kind of pilot signal for estimating a location or a speed of a target. For example, each base station may carry and transmit the data stream in a beamforming matrix for data communication and, at the same time, may carry and transmit a radar signal for wireless sensing in the beamforming matrix.

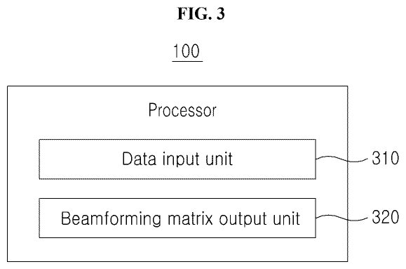

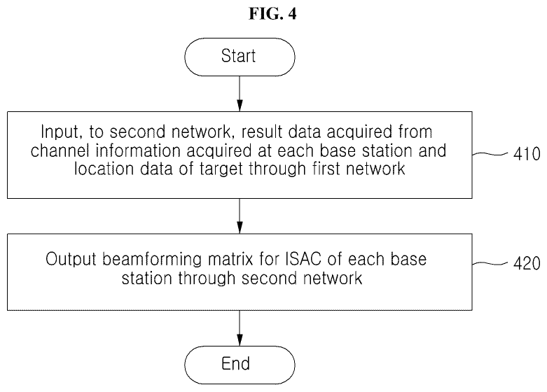

FIG. 3 is a block diagram illustrating a cooperative ISAC system according to an example embodiment, and FIG. 4 is a flowchart illustrating a multi-base station-based cooperative ISAC method according to an example embodiment.

A processor of a cooperative ISAC system 100 may include a data input unit 310 and a beamforming matrix output unit 320. Components of this processor may be representations of different functions performed by the processor in response to a control instruction provided from a program code stored in the cooperative ISAC system 100. The processor and the components of the processor may control the cooperative ISAC system 100 to perform operations 410 and 420 included in the multi-base station-based cooperative ISAC method of FIG. 4. Here, the processor and the components of the processor may be implemented to execute a code of an operating system (OS) included in a memory and a code of at least one program.

The processor may load, to the memory, a program code stored in a file of a program for the multi-base station-based cooperative ISAC method. For example, when the program is executed in the cooperative ISAC system 100, the processor may control the cooperative ISAC system 100 to load the program code from the file of the program to the memory under control of the OS. Here, the data input unit 310 and the beamforming matrix output unit 320 may be different functional expressions of the processor for executing operations 410 and 420 by executing an instruction of a corresponding portion in the program code loaded to the memory.

In operation 410, the data input unit 310 may input, to a second network, result data acquired from channel information acquired at each base station and location data of a target through a first network. In advance, each base station may acquire channel information by estimating a channel between a user terminal and the base station, and may transmit location data of a target in a previous timestamp to a central apparatus based on the channel information acquired at each base station and a current timestamp. The central apparatus may deliver, to each base station, result data acquired using the location data of the target in the previous timestamp based on the channel information acquired at each base station and the current timestamp through the first network.

In operation 420, the beamforming matrix output unit 320 may output a beamforming matrix for ISAC of each base station through the second network. The beamforming matrix output unit 320 may output the beamforming matrix for ISAC of each base station using the result data delivered from the central apparatus through the second network. The beamforming matrix output unit 320 may perform downlink-based ISAC by multiplying the output beamforming matrix for ISAC of each base station by a data stream and a radar signal for communication. The beamforming matrix output unit 320 may support communication traffic of a user terminal, and at the same time, may estimate location data of a target through a beam formed based on the output beamforming matrix for ISAC of each base station.

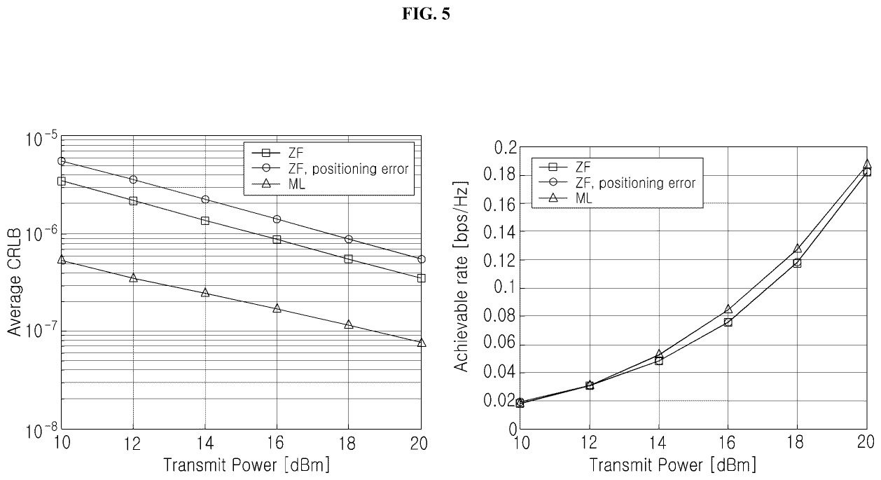

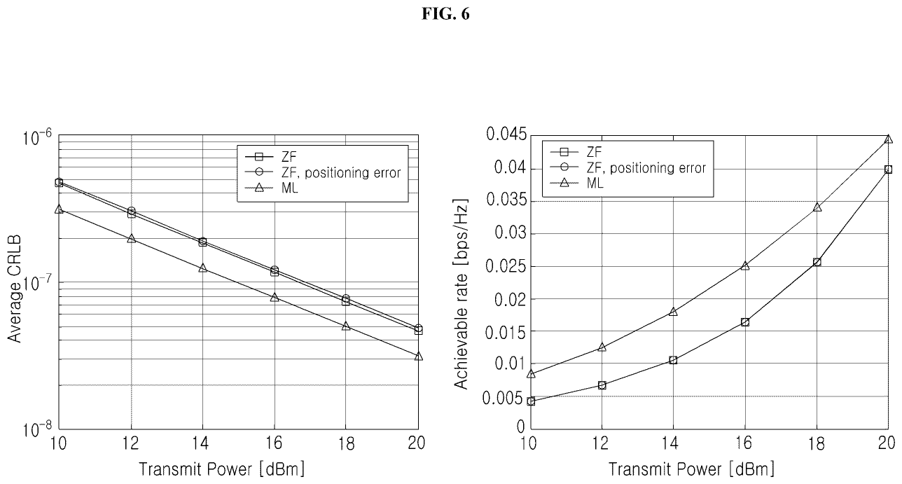

FIGS. 5 and 6 are graphs showing technical effect of a multi-base station-based cooperative ISAC method proposed herein according to an example embodiment.

In FIGS. 5 and 6, ZF refers to a technique of forming an ISAC beam in a base station using a zero-forcing beamforming technique and it is assumed that current location data of a sensing target may be accurately known (previously estimated location data of target barely varies). ZF, positioning error refers to a case in which zero-forcing beamforming is used, but a positioning error is present due to a change in location data of the sensing target estimated in the previous timestamp. ML refers to a technique proposed herein and a positioning error is present.

FIG. 5 is a graph showing results of measuring CLRB and a transmission rate of cooperative ISAC technology proposed herein.

The ZF-based ISAC beamforming technique has a limitation in that, when a positioning error is present in location information of a target as shown in a graph on the left, e CRLB increases, that is, sensing performance deteriorates. On the contrary, it can be seen that the technique (ML) proposed herein achieves lower CRLB compared to the conventional ZF-based ISAC beamforming technique although the positioning error is present.

The technique proposed herein has the advantage that it is possible to adjust a transmission rate and sensing performance by appropriately adjusting a weight parameter multiplied by the transmission rate and CRLB. In FIG. 5, it can be seen that the technique proposed herein of adjusting the transmission rate by adjusting the parameter and the transmission rate of another technique are similarly matched and, under condition of achieving a similar transmission rate, the proposed technique achieves lower CRLB (higher sensing accuracy) compared to the other technique.

FIG. 6 is a graph showing results of measuring CRLB and a transmission rate by introducing the proposed cooperative ISAC technology in a different environment and different weights.

FIG. 6 shows results of an experiment by introducing different weights in different channel environments, and it can be seen that the proposed technology achieves excellent performance compared to comparative target techniques in terms of sensing performance (CRLB) and the transmission rate.

According to example embodiments, it is possible to optimize a complex multi-base station-based ISAC network using deep learning and to form a beam for ISAC robust against a location estimation error by performing learning based on location data in the existing timestamp.

The apparatuses described herein may be implemented using hardware components, software components, and/or combination of the hardware components and the software components. For example, a processing device and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to example embodiments may be implemented in a form of a program instruction executable through various computer methods and recorded in non-transitory computer-readable media. The media may include, alone or in combination with program instructions, a data file, a data structure, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of program instructions include a machine code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed:

1. A multi-base station-based cooperative integrated sensing and communication (ISAC) method performed by a cooperative ISAC system, the cooperative ISAC method comprising:
inputting, to a second network, result data acquired from channel information acquired at each base station and location data of a target through a first network; and
outputting a beamforming matrix for ISAC of each base station through the second network.

2. The cooperative ISAC method of claim 1, wherein the first network and the second network are connected and trained as a single neural network.

3. The cooperative ISAC method of claim 2, wherein the first network is processed at a central apparatus, and the second network is processed at each base station.

4. The cooperative ISAC method of claim 2, wherein the first network and the second network are configured as a fully-connected network or a convolutional neural network.

5. The cooperative ISAC method of claim 2, wherein the first network and the second network are trained to maximize a weighted sum of a negative value of a measure of evaluating sensing performance and a transmission rate that is an index of evaluating communication performance.

6. The cooperative ISAC method of claim 1, further comprising:
acquiring channel information from each base station by estimating a channel between a user terminal and the base station.

7. The cooperative ISAC method of claim 6, further comprising:
transmitting location data of a target in a previous timestamp to a central apparatus based on the channel information acquired from each base station and a current timestamp.

8. The cooperative ISAC method of claim 7, wherein the central apparatus is configured to deliver, to each base station, result data acquired using the location data of the target in the previous timestamp based on the channel information acquired at each base station and the current timestamp through the first network.

9. The cooperative ISAC method of claim 1, wherein the outputting comprises performing downlink-based ISAC by multiplying the output beamforming matrix for ISAC of each base station by a data stream and a radar signal for communication.

10. The cooperative ISAC method of claim 9, wherein the outputting comprises supporting communication traffic of a user terminal, and at the same time, estimating location data of a target through a beam formed based on the output beamforming matrix for ISAC of each base station.

11. A non-transitory computer-readable recording medium storing instructions that, when executed by a processor, cause the processor to perform a multi-base station-based cooperative integrated sensing and communication (ISAC) method performed by a cooperative ISAC system, the cooperative ISAC method comprising:
inputting, to a second network, result data acquired from channel information acquired at each base station and location data of a target through a first network; and
outputting a beamforming matrix for ISAC of each base station through the second network.

12. A multi-base station-based cooperative integrated sensing and communication (ISAC) system comprising:
a data input unit configured to input, to a second network, result data acquired from channel information acquired at each base station and location data of a target through a first network; and
a beamforming matrix output unit configured to output a beamforming matrix for ISAC of each base station through the second network.

13. The cooperative ISAC system of claim 12, wherein the first network and the second network are connected and trained as a single neural network, the first network is processed at a central apparatus, and the second network is processed at each base station.

14. The cooperative ISAC system of claim 12, wherein the first network and the second network are configured as a fully-connected network or a convolutional neural network.

15. The cooperative ISAC system of claim 12, wherein the first network and the second network are trained to maximize a weighted sum of a negative value of a measure of evaluating sensing performance and a transmission rate that is an index of evaluating communication performance.

16. The cooperative ISAC system of claim 12, wherein the cooperative ISAC system is configured to acquire channel information from each base station by estimating a channel between a user terminal and the base station.

17. The cooperative ISAC system of claim 16, wherein the cooperative ISAC system is configured to transmit location data of a target in a previous timestamp to a central apparatus based on the channel information acquired from each base station and a current timestamp.

18. The cooperative ISAC system of claim 17, wherein the central apparatus is configured to deliver, to each base station, result data acquired using the location data of the target in the previous timestamp based on the channel information acquired at each base station and the current timestamp through the first network.

19. The cooperative ISAC system of claim 12, wherein the beamforming matrix output unit is configured to perform downlink-based ISAC by multiplying the output beamforming matrix for ISAC of each base station by a data stream and a radar signal for communication.

20. The cooperative ISAC system of claim 19, wherein the beamforming matrix output unit is configured to support communication traffic of a user terminal, and at the same time, to estimate location data of a target through a beam formed based on the output beamforming matrix for ISAC of each base station.
